(19) United States
(12) Patent Application Publication
(10) Pub. No.: US 2018/0365783 A1
(43) Pub. Date: Dec. 20, 2018

(54) ROI web based learning and training development solution

(71) Applicant: Chris Straley, Columbus, OH (US)

(72) Inventor: Chris Straley, Columbus, OH (US)

(21) Appl. No.: 15/623,377

(22) Filed: Jun. 14, 2017

(51) Int. Cl. G06Q 50/20; G06Q 10/06

(52) U.S. Cl. CPC G06Q 50/2057; G06Q 10/0637; G06Q 10/067; G06Q 10/06313

(57) ABSTRACT

This current invention is a system and app is aimed to make it easy for companies to create and deliver institutional training programs. The cloud-based service provides end-to-end support of the learning development process. The projects allow for creation and modification of trainings, and also has a calculator to determine time-based costs required to build a training solution. Any of the forms can be saved and/or printed.

### CROSS-REFERENCES TO RELATED APPLICATIONS (IF ANY)

None

### BACKGROUND

### 1. Field of the Invention

The present invention relates to a process to generate work place training, provide workplace training, and calculate the labor-based costs required to complete training tasks.

### 2. Description of Prior Art

Project Management Platforms are a dime a dozen, and in order to capture the most customers, they usually offer generic tools that do not cater to a specific industry. The result: customers use a platform that acts as a documentation and planning repository, but does nothing to assist in the design and development of the project itself. The current invention changes all that by offering an online platform that supports the design and development of learning projects specifically.

There is still room for improvement in the art.

### SUMMARY OF THE INVENTION

The current invention is a cloud-based toolkit and system that simultaneously teaches instructional processes while providing a project management structure under which the user may practice them.

The current invention has two main components:

1. A project management platform and toolbox structured specifically for learning & development that will help customers navigate each step of design and development. The ADDIE model is the generic process traditionally used by instructional designers and training developers. The five phases—Analysis, Design, Development, Implementation, and Evaluation—represent a dynamic, flexible guideline for building effective training and performance support tools. The platform will include tools specific to all five phases of ADDIE such as scoping forms, questionnaires, timelines, design templates, development templates, measurement tools, and implementation guides.
2. A Timeline and Cost Calculator that applies geographic-specific market analysis and requirement inputs to provide total costs in both hours and money necessary to build learning solutions.”

The current invention is a system and application in which the user can build and monitor the performance of institutional training for employees, as well as estimate labor hours to complete training modules.

The innovative process is more efficient, effective, accurate and functional than the current art. It creates efficiency by offering a structured, repeatable framework to execute a generic process.

### BRIEF DESCRIPTION OF THE DRAWINGS

Without restricting the full scope of this invention, the preferred form of this invention is illustrated in the following drawings:

FIG. 1 shows an overview of how Users access the system;

FIG. 2 shows a course screen;

FIG. 3 shows a course data screen;

FIG. 4 shows a course data screen;

FIG. 5 shows a cost projects screen for labor;

FIG. 6 shows a cost total screen; and

FIG. 7 shows a project cost screen.

### DESCRIPTION OF THE PREFERRED EMBODIMENT

There are a number of significant design features and improvements incorporated within the invention.

The current invention is a cloud-based tool and system that simultaneously teaches instructional processes while providing a project management structure under which the user may practice them.

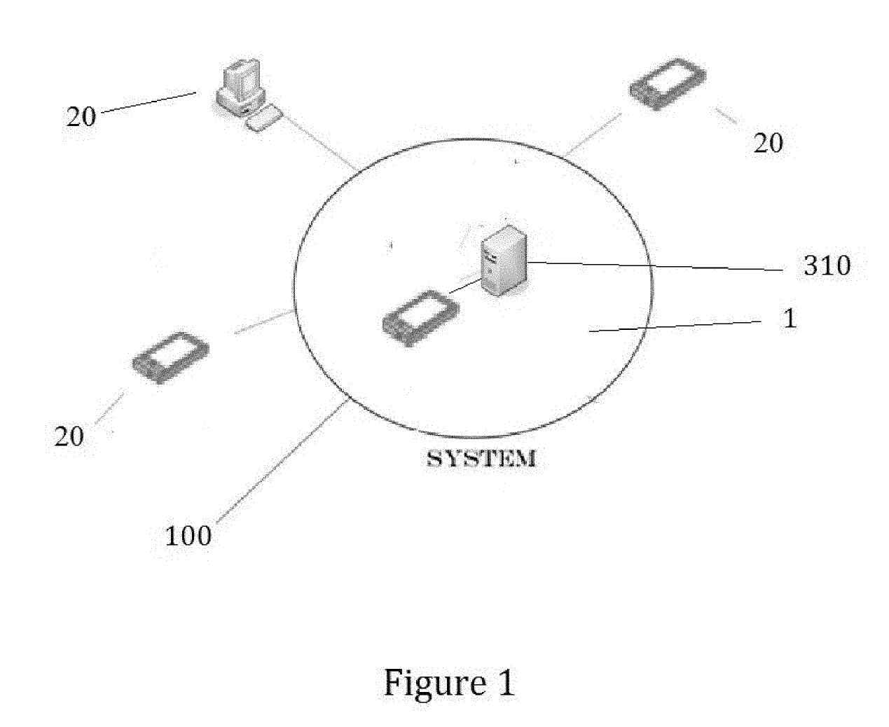

FIG. 1 displays the preferred embodiment of the system architecture 1 accessed through the cloud 500. However, the system could be implemented on a device-to-device or client/server architecture as well.

In FIG. 1, the system 1 is accessed from a user's computing device 20 through a web browser over HTTP and/or HTTPS protocols or wireless network or cell phone to cell phone connection. A computing device 20, such as a cell phone, that can access the system 1 must have some version of a CPU, CPU memory, local hard disk, keyboard/keypad/input and display unit. The computing device 20 can be any desktop, laptop, tablet, smart phone or general purpose computing device with an appropriate amount of memory suitable for this purpose and an active connection to the cloud 500. Computing devices like this are well known in the art and are not pertinent to the invention.

The system 1, data and processing code can reside in the non-transitory memory 310 of the one or more computing devices. The system 1 may work with a central server as shown in FIG. 1 or in parallel which each computing device 10 or smartphone communicating with others within the system 1. Any programming language and operating system can be used to run the system 1.

The system 1, data and processing code can reside in the non-transitory memory 310 of the one or more computing devices.

This current invention is a system 1 and app is aimed to make it easy to development and implement cloud-based institutional trainings as well as instructor-led training. It is a system and computer application (app) in which the user can create training modules, as well as calculate estimates for time required to complete the construction of the training. The system 1 will include each user feature separate from the other or combined.

The current invention has two main components:

1. A project management platform and toolkit structured specifically for learning & development that will help customers navigate each step of design and development. They system 1 will use the ADDIE model, which is the generic process traditionally used by instructional designers and training developers. The five phases—Analysis, Design, Development, Implementation, and Evaluation—represent a dynamic, flexible guideline for building effective training and performance support tools. The platform will include tools specific to all five phases of ADDIE such as scoping forms, questionnaires, timelines, design templates, development templates, measurement tools, and implementation guides.
2. A Timeline and Cost Calculator that applies geographic-specific market analysis and requirement inputs to provide total costs in both hours and money necessary to build learning solutions.

A user can create institutional training for employees, as well as estimate Labor hours required to execute it's construction. This invention includes each user feature separate from the other or combined.

The process would be that a user would register and login.

At a home page, public content includes a search option with criteria, a “company overview, product information, sample offerings, and research links.” There are also links to log-in or follow a link to register. Membership may begin with a free trial. User can go to a “shopping cart” site, which allows viewing prior subscriptions, to select memberships by monthly or annual payments, and pay online through a service such as PayPal and Stripe. Upon payment, members will receive an invoice. “After successful subscription, user will receive a unique login ID with a password, which can be changed.”

At log-in screen, user inputs username and password to access member area. Program checks to ensure account is only logged in once at a time (can only operate on a single device at a time). A link is available to request to recover a password.

Upon creating and logging into an account, access is granted to a “member-only areas that consist of the majority of the toolkit and the timeline/cost calculator.”

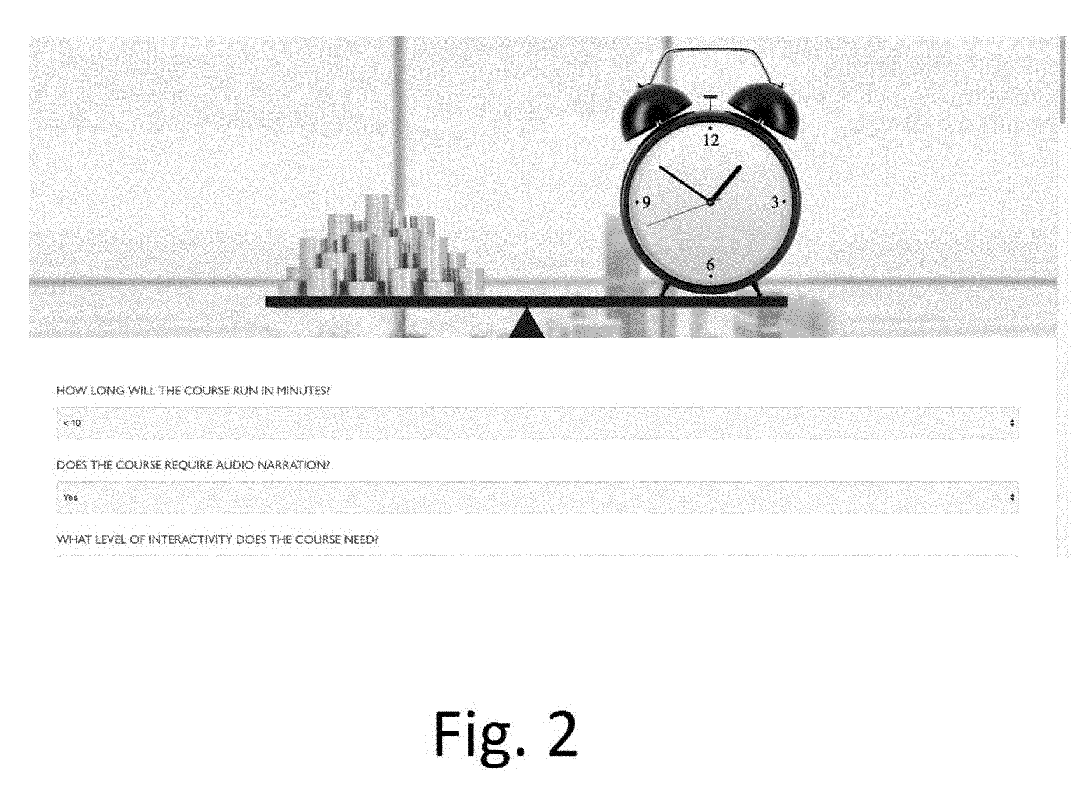

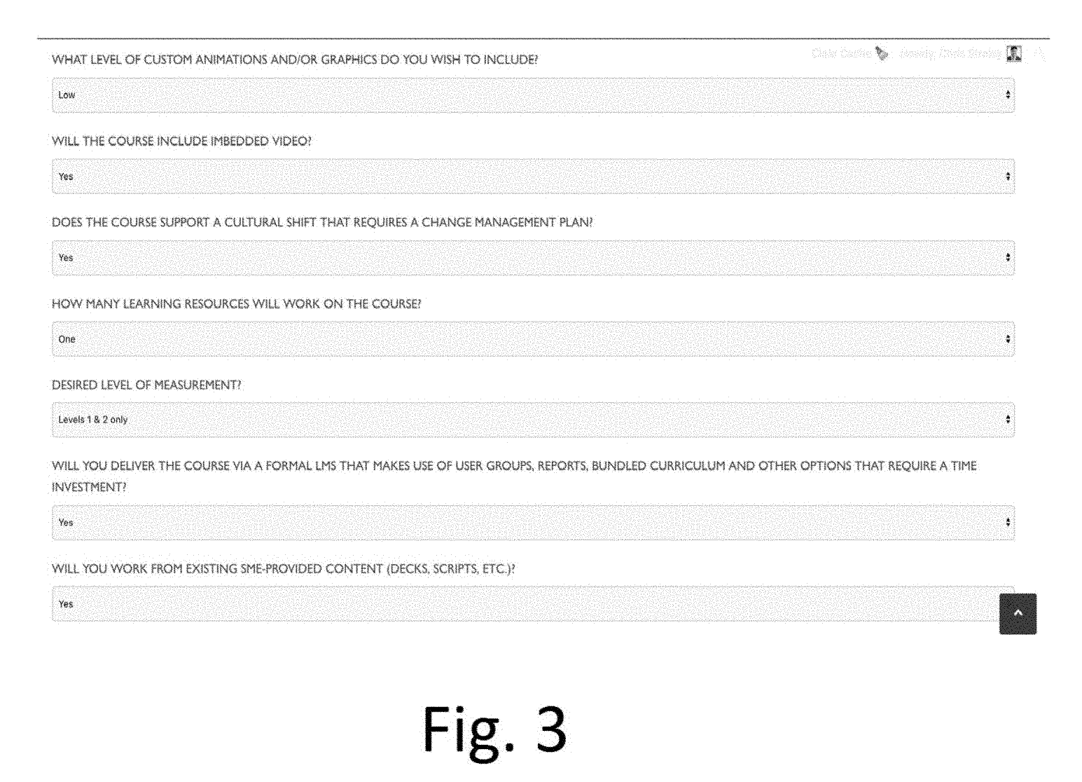

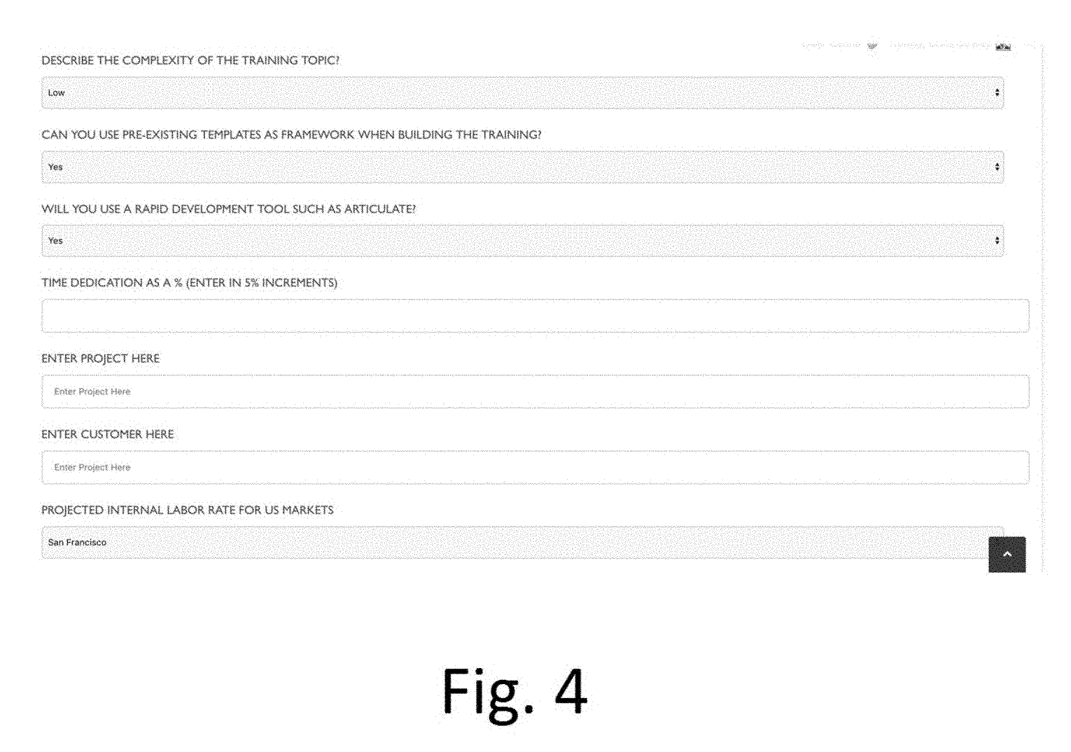

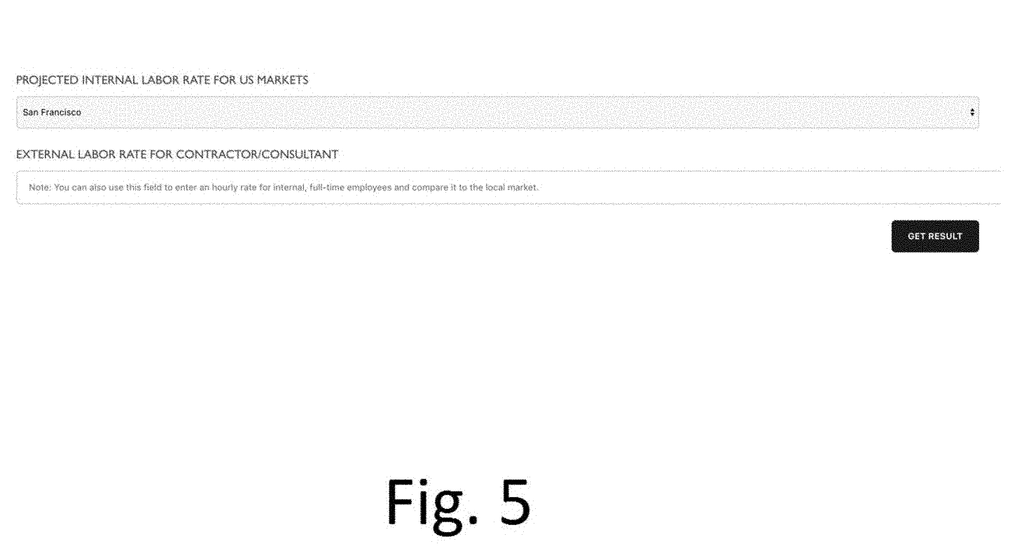

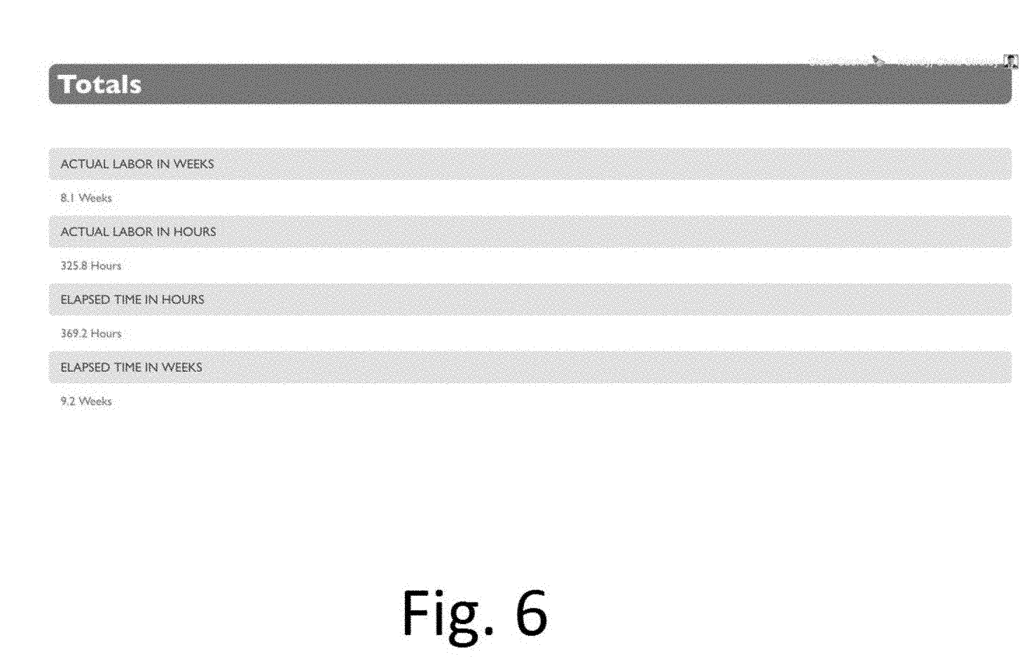

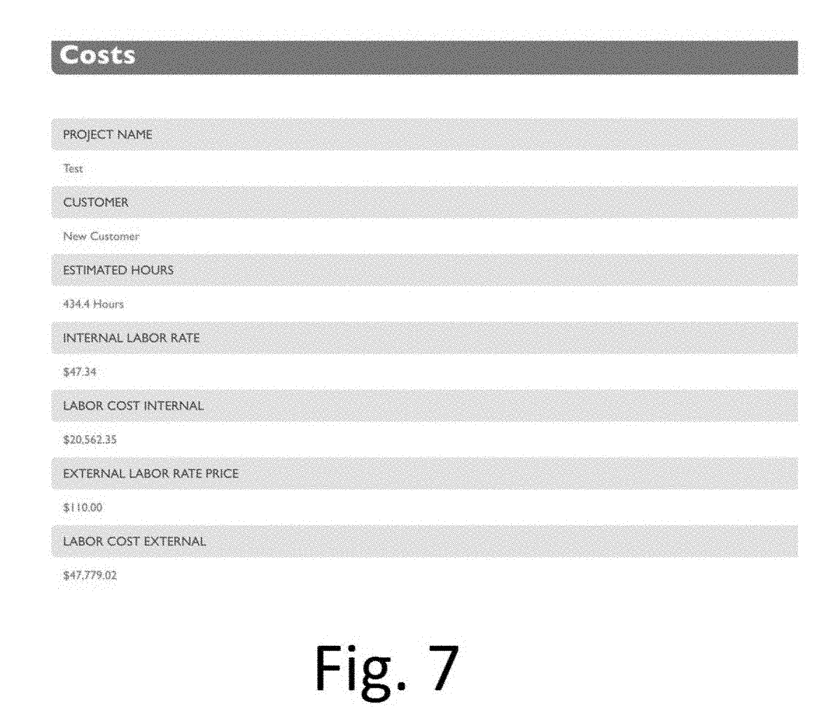

FIGS. 2 through 7 show some of the potential screens of the system 1.

The toolkit includes the following components.

Solicit Performance Support, which speeds up the process for both the customer and the learning professionals who field requests by gathering key information necessary to start analysis on day one.

As part of the toolbox, the system 1 will ask “Do You Need Training?” Contrary to popular belief, training does not solve all performance issues. This tool walks through specific questions to determine if training or another solution would best meet the requestor's needs.

The toolbox's Learning Objective Builder section provides the foundation for learning solutions by outlining targets that tie directly to the business need or other stated goal of the requestor. Increase your ability to evaluate ROI by starting with observable and measurable objectives.

Solution Proposal section provides SMEs, sponsors and others with a clear, concise summary that outlines how a proposed solution will support knowledge and skill development.

The system's toolbox will provide Timelines that help everyone involved stay on task and learn about their role in the learning development process. Instructional Design Genius includes custom project timelines for both instructor-led and eLearning solutions.

The system's toolbox will have an eLearning Development Checklist. Creating an engaging eLearning takes a lot more effort than posting a presentation or instructor-led class content online. The users learn all about it and hone their process by using the eLearning Checklist.

The toolbox's Roles & Responsibilities section sets clear role definitions that promotes effective project management. Start everyone on the same page by outlining responsibilities of four key roles: instructional designer, eLearning developer, project sponsor and subject matter expert.

The system's toolbox will have an ILT Development Checklist. The checklist is used for a strong instructor-led class that is engaging, informational, interactive, easy-to-deliver, and digestible for the learner.

The system's toolbox will have Storyboard Templates for such items like capture SME, sponsor and peer feedback during the design phase to create alignment and avoid unnecessary rework. The storyboard template provides a structure to create a script, outline visual concepts, and structure content flow.

The system's toolbox would have Instructor-Led Training Templates. These templates helps to speed up development, to promote consistency and to support the facilitators who deliver training. It allows users to jump in with both feet without struggling with cumbersome formatting issues.

The system's toolbox would have eLearning Recommendations where the user would learn about eLearning tools, best design principles, and more with the eLearning recommendations tool.

The system supports the creation of the training deliverables. End users (learners) will complete those deliverables on an individual's or company's learning management system (LMS) where they are stored.

The system's toolbox would have a Production Review Form. This form captures feedback from SMEs, sponsors, and pilot groups which requires organization and a clear process. The Production Review Form creates structure and makes it easier on both those providing feedback and the learning professional responsible for implementing it.

The system's toolbox also provides a job aid for recording audio. eLearning, video lessons, simulations, and even instructor-led classroom activities often incorporate audio.

The toolbox offers framework for Communication Campaign building to drive awareness and desire to complete a training, both of which play as large a role in the success of a learning initiative as the content itself. Create messaging that not only explains the purpose behind training but demonstrates value.

The toolbox guides Audience Prioritization as even the greatest training in the world won't make the intended impact if distributed to the wrong audience. This function increases success rates by narrowing the focus to those who can put lessons into action.

The toolbox will have Functional Testing. Just like the manufacturing and service industries, learning and development professionals use quality control to put out the best possible product. Conduct functional testing to fill that need.

The toolbox will have User Experience Testing. No product or service is perfect the first time. Apply user experience testing to capture feedback from the intended audience and iterate.

The toolbox will have a Learning Management System Checklist. Most learning solutions use an LMS to act as the interface between content and the participant. The LMS Checklist illustrates what this requires from learning professionals.

With all the functions and applications in the toolbox it will provide measuring Training Impact, the results, real-life impact, ROI and other information that the user or leadership wants. The toolbox as a whole, and in particular, the Measuring Training Impact Tool, provide a framework to measure ROI

The user can alter the display settings for the toolkit, such as “color, font, and logo when exporting or saving their forms.

The system 1 has a Timeline and Cost Calculator that applies geographic-specific market analysis and requirement inputs to provide total costs in both hours and money necessary to build learning solutions. The cost calculator is used to sum up the project's costs.

The calculator is specific to the creation of E-LEARNING. The calculator estimates time and cost for e-learning. The calculator provides estimates in both elapsed time and “real” actual time to provide an additional layer of information. It also includes a work effort adjustment factor to account for the fact that no one can dedicate 100 percent of their workday to a specific project. It also includes weighted adjustments to account for the fact that not all requirements impact time & cost equally.

For any form on the system 1, there is an option to output as a PDF, save, and print.

### Operation

Service user can create training modules within a larger training project. All forms can be saved and printed. A calculator can be used to generate time estimates for completing a training project.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A project management system comprising;
having a system that resides in the non-transitory memory of a computing device;
said system have a project management toolbox; and
a timeline and cost calculator.

2. A system according to claim 1 having the have plurality of functions.

3. A system according to claim 1 having a project management platform and toolkit structured for learning and development.

4. A system according to claim 3 using the ADDIE model.

5. A system according to claim 4 where the ADDIE model has five phases, Analysis, Design, Development, Implementation, and Evaluation.

6. A system according to claim 1 having one or more tools consisting of forms, questionnaires, timelines, design templates, development templates, measurement tools, and implementation guides.

7. A system according to claim 1 providing estimate Labor hours required.

8. A system according to claim 1 having a login and a password function.

9. A system according to claim 1 where the toolbox will have Functional Testing function.

10. A system according to claim 1 where the toolbox will have an eLearning Development Checklist.

11. A system according to claim 1 where the toolbox will have User Experience Testing function.

12. A system according to claim 1 where the toolbox will have a Learning Management System Checklist.

13. A system according to claim 1 where the toolbox provide measuring Training Impact, the results, real-life impact, ROI and other information that the user or leadership wants.

14. A system according to claim 1 where the toolbox has a Measuring Training Impact Tool that provides a framework to measure ROI
